(19) United States
(12) Patent Application Publication
(10) Pub. No.: US 2018/0042312 A1
(43) Pub. Date: Feb. 15, 2018

(54) JACKET HAVING A WARMING/COOLING TUBE AND COMPONENTS THEREOF AND METHODS OF USING AND MAKING THE SAME

(71) Applicant: ACE Engineering, Warren, MI (US)

(72) Inventor: Adam E. Clifton, Warren, MI (US)

(21) Appl. No.: 15/671,690

(22) Filed: Aug. 8, 2017

Related U.S. Application Data
(60) Provisional application No. 62/373,619, filed on Aug. 11, 2016.

(51) Int. Cl. A41D 13/002; A41D 3/00; B60H 1/00

(52) U.S. Cl. CPC A41D 13/0025; B60H 1/00264; B60H 1/00592; A41D 3/00

(57) ABSTRACT

A jacket having a warming/cooling tube, the tube having an open end communicating with a body cavity of the jacket, the tube having a second open end, the tube being constructed and arranged to connect the second end to a heating, ventilation, and air conditioning outlet vent of a vehicle.

This application claims the benefit of U.S. Provisional Application Ser. No. 62/373,619 filed Aug. 11, 2016.

### TECHNICAL FIELD

The field to which the disclosure generally relates to includes jackets, components thereof, and methods of making and using the same.

### BACKGROUND

Individuals have been known to ride in vehicles with a jacket on.

### SUMMARY OF ILLUSTRATIVE VARIATIONS

A number of variations may include a jacket having a warming/cooling tube, the tube having an open end communicating with a body cavity of the jacket, the tube having a second open end, the tube being constructed and arranged to connect the second end to a heating, ventilation, and air conditioning outlet vent component of a vehicle.

A number of variations may include a heating, ventilation, and air conditioning outlet vent coupling or clip constructed and arranged to attach to a heating, ventilation, and air conditioning outlet vent component of a vehicle and to a warming/cooling tube of a jacket.

A number of variations may include a heating, ventilation, and air conditioning outlet vent component having a vent opening and a collar portion surrounding the vent opening. The collar portion having a groove formed in an outer surface there of constructed and arranged to receive a O-ring of a warming/cooling tube of a jacket.

Other illustrative variations within the scope of the invention will become apparent from the detailed description provided hereinafter. It should be understood that the detailed description and specific examples, while disclosing variations of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 illustrates a jacket according to a number of variations.

FIG. 2 illustrates a jacket having a warming/cooling tube connected to a heating, ventilation, and air conditioning (HVAC) outlet vent of a vehicle according to a number of variations.

FIG. 3 illustrates a jacket having a warming/cooling tube, a first attachment feature connected to or sewn into the warming/cooling tube, and a vent coupling or clip attached to the first attachment feature according to a number of variations.

FIG. 4 illustrates a vent coupling or clip attached to a HVAC outlet vent of a vehicle according to a number of variations.

FIG. 5 illustrates a jacket having a warming/cooling tube, attached to a HVAC outlet vent of a vehicle by way of a first attachment feature and a vent coupling or clip according to a number of variations.

FIG. 6 illustrates the inside of a jacket showing a warming/cooling tube having a first end 28 communicating with a body cavity portion of the jacket according to a number of variations.

FIG. 7 illustrates a jacket having a warming/cooling tube and an attachment feature including an O-ring sewn into a first end of the warming/cooling tube according to a number of variations.

FIG. 8 illustrates a vent coupling or clip according to a number of variations.

FIG. 9 illustrates a vent coupling or clip according to a number of variations.

FIG. 10 illustrates a jacket including a storage pocket for a warming/cooling tube.

### DETAILED DESCRIPTION OF ILLUSTRATIVE VARIATIONS

The following description of the variations is merely illustrative in nature and is in no way intended to limit the scope of the invention, its application, or uses.

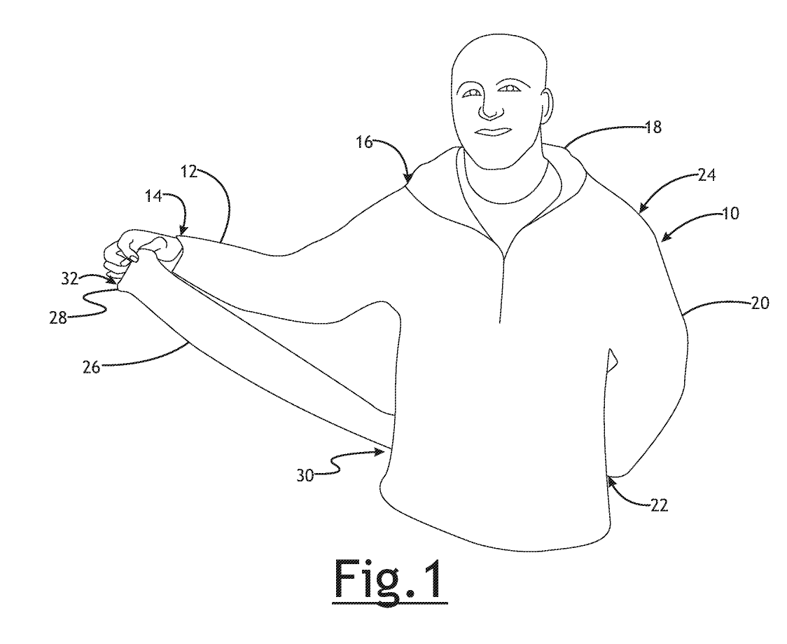

FIG. 1 illustrates a jacket 10, which in a number of variations, may include a first sleeve 12 having a first open end 14, through which a person's hand may extend, and a second end 16 communicating with a body cavity portion 18 defined by the jacket and constructed and arranged to receive the torso of a person. The jacket 10 may also include a second sleeve 20 having a first open end 22, through which a person's hand may extend, and a second end 24 communicating with the body cavity portion 18 defined by the jacket 10. In a number of variations the jacket 10 may include a warming/cooling tube 26. In a number of variations the warming/cooling tube 26 may comprise a fabric. In a number of variations the fabric may include nylon, polyester, cotton or other known clothing materials. In a number of variations the weave of the fabric may be sufficiently tight enough to prevent warm or cool air flowing through the tube 26 from exiting the tube 26 at locations other than the first open end 28. A second end 30 of the warming/cooling tube communicates with the body cavity portion 18 and is constructed and arranged so that warm or cool air by be delivered through the second end 30 of the tube 26 into the body cavity portion 18.

FIG. 10 illustrates a number of variations wherein the jacket 10 may include a hand warming pouch 11, attached to the front of a torso section 15 of the jacket which may be constructed and arranged to conceal the connection point of the second end 30 of the warming/cooling tube 26 and into which the warming/cooling tube 26 may be stored when not in use. In a number of variations, a pocket 13 may be provided on the inside of the hand warming pouch or on the outer portion of the jacket underneath the hand warming pouch into which the warming/cooling tube may also be stored.

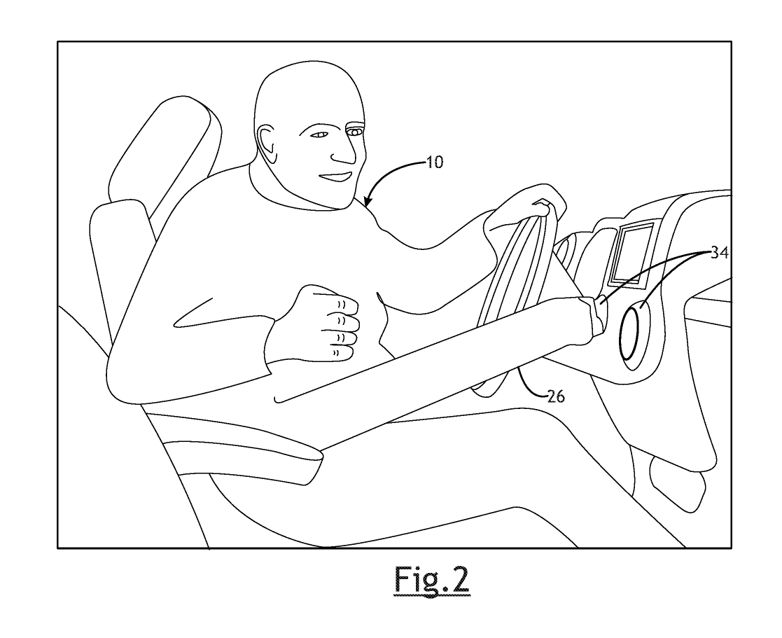

FIG. 2 illustrates a driver of a vehicle wearing a jacket 10 having a warming/cooling tube 26 connected to an HVAC outlet vent of the vehicle. In a number of variations the vehicle may be an automobile, truck, motorcycle, snowmobile or a vehicle capable of traveling off road include a vehicle known as a JEEP. In a number of variations, the vehicle may have a convertible top, removable top or removable doors. The user of the jacket 10 may adjust the HVAC system of the vehicle to deliver heated air through the HVAC outlet vent 34 and into the warming/cooling tube 26 to heat the torso and/or arms of the jacket wearer. Similarly, the wearer of the jacket 10 may adjust the HVAC system to deliver cooled air through the HVAC vent 34 and through the warming/cooling tube to cool the torso and/or arms of the jacket wearer.

In a number of variations the tube may have a diameter at the first end 28 and the second end 30 that is less than 3 inches. In a number of variations the tube 26 may have a diameter throughout it length that is the same or substantially the same. In a number of variations the tube 26 may have a diameter throughout its length that is less than 3 inches.

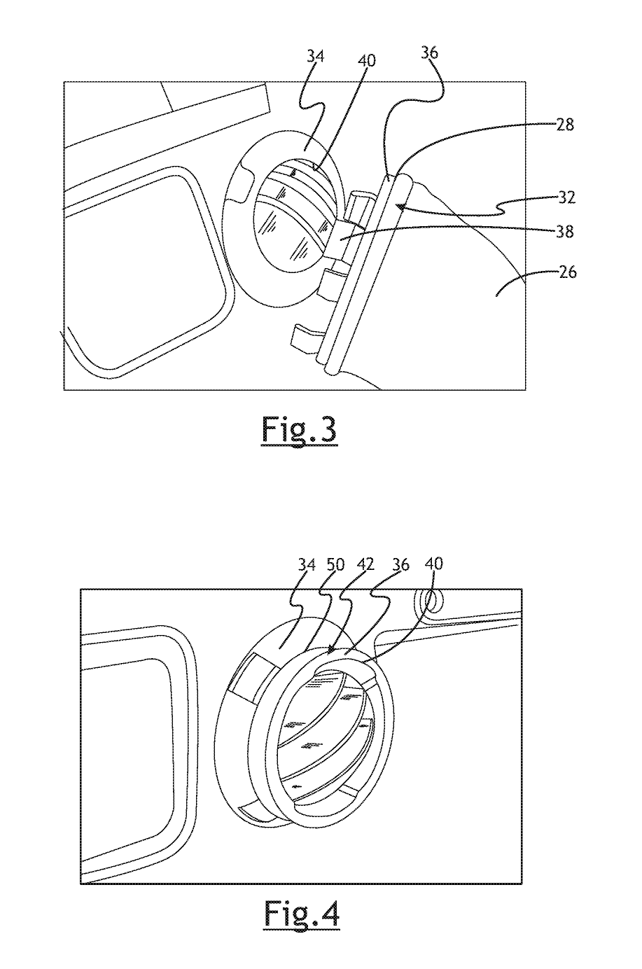

FIG. 3 illustrates a portion of a jacket warming/cooling tube 26 having an attachment feature in the form of a flexible O-ring 32 sewn into a first end 28 of the warming/cooling tube 26. A vent coupling or clip 36 is attached to the first attachment feature 32. The first attachment feature 32 may include a plurality of spaced apart attachment features 38, such as but not limited to flexible fingers constructed and arranged to be frictionally fit into the opening defined by an edge 40 of the HVAC vent 34.

FIG. 4 illustrates a number of variations. In a number of variations a vent coupling or clip 36 may be frictionally received in the opening defined by an edge 40 of an HVAC vent 34 of a vehicle. The vent coupling or clip 36 may have a groove 46 formed in a collar portion 50 thereof. The groove 42, in a number of variations, may be arch shaped and constructed and arranged to receive at least a portion of an O-ring which is attached to or sewn into the warming/cooling tube 26 of the jacket. In a number of variations the vent component 34 and the coupling or clip 36 are not separate pieces. In a number of variations the vent component 34 defined an opening through which heated or cooled air may be delivered into the passenger area. In a number of variations the vent component 35 includes a collar portion 50 extend in the axial direction of the opening defined by an edge 40 of the vent component 34. In a number of variations a groove 46 may be formed in a collar portion 50 and the groove 46 may be arch shaped and constructed and arranged to receive at least a portion of an O-ring which is attached to or sewn into the warming/cooling tube 26 of the jacket.

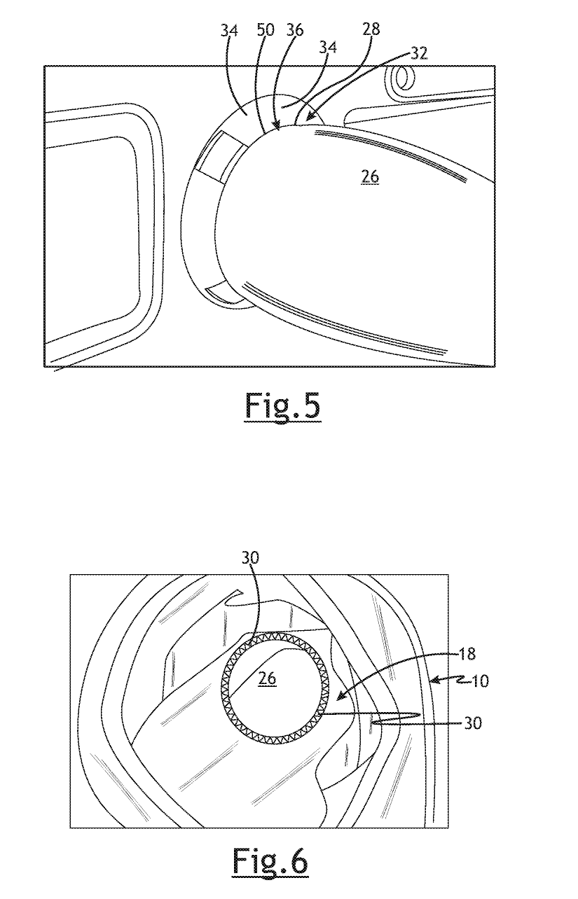

FIG. 5 illustrates a warming/cooling tube 26 of a jacket having an O-ring 32 sewn into a first end 28 of the tube 26 and received in a groove formed in a collar portion 50 of a vent coupling or clip 36 attached to the HVAC vent 34.

FIG. 6 illustrates a jacket 10 showing a portion of the inside of the jacket including the connection of a second end 30 of the tub 26 to communicate with the body cavity 18 defined by the jacket 10.

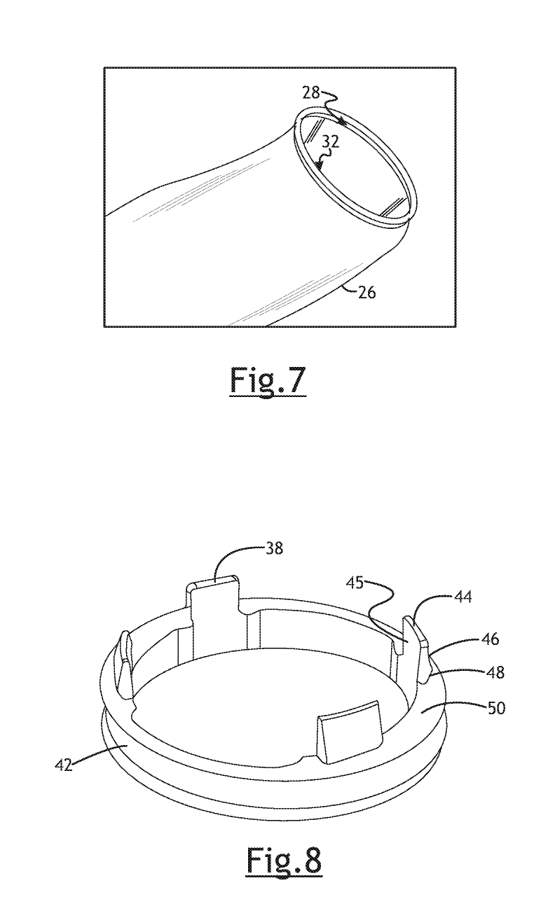

FIG. 7 illustrates a warming/cooling tube 26 of a jacket having an O-ring 32 sewn into a first end 28 of the tube 26.

FIG. 8 illustrates a vent coupling or clip 36 which, in a number of variations may include an annular shaped collar 50 having a groove 42 formed in an outer surface thereof and constructed and arranged to receive an O-ring attached to or sewn into a first end of a warming/cooling tube 26 of the jacket. A plurality of spaced apart attachment features 38 may extend actually from the collar 50. The flexible fingers 38 may have a free end 44, an inner surface 55 and outer surface having a first portion 46 tapering towards the free end 44. The tapered portion 46 may be connected to a base 48 connecting to the collar 50.

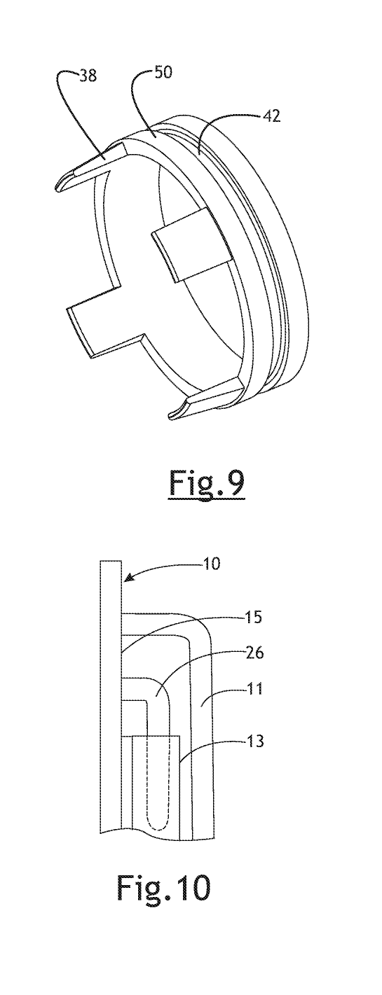

FIG. 9 illustrates a vent coupling or clip 36 according to a number of variations.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include a jacket having a warming/cooling tube, the tube having an open end communicating with a body cavity of the jacket, the tube having a second open end, the tube being constructed and arranged to connect the second end to a heating, ventilation, and air conditioning outlet vent component of a vehicle.

A number of variations may include a heating, ventilation, and air conditioning outlet vent coupling or clip constructed and arranged to attach to a heating, ventilation, and air conditioning outlet vent of a vehicle and to a warming/cooling tube of a jacket.

A number of variations may include a heating, ventilation, and air conditioning outlet vent component having a vent opening and a collar portion surrounding the vent opening. The collar portion having a groove formed in an outer surface there of constructed and arranged to receive a O-ring of a warming/cooling tube of a jacket.

The above description of select variations within the scope of the invention is merely illustrative in nature and, thus, variations or variants thereof are not to be regarded as a departure from the spirit and scope of the invention.

What is claimed is:

1. A jacket having a warming/cooling tube, the tube having an open end communicating with a body cavity of the jacket, the tube having a second open end, the tube being constructed and arranged to connect the second end to a heating, ventilation, and air conditioning outlet vent of a vehicle.

2. A heating, ventilation, and air conditioning outlet vent coupling or clip constructed and arranged to attach to a heating, ventilation, and air conditioning outlet vent of a vehicle and to a warming/cooling tube of a jacket.

3. A heating, ventilation, and air conditioning outlet vent component having a vent opening and a collar portion surrounding the vent opening, the collar portion having a groove formed in an outer surface there of constructed and arranged to receive a O-ring of a warming/cooling tube of a jacket.
